(19) United States
(12) Patent Application Publication
(10) Pub. No.: US 2006/0157531 A1
(43) Pub. Date: Jul. 20, 2006

(54) Single body friction stir welding tool for high melting temperature materials

(76) Inventors: Scott M. Packer, Alpine, UT (US); Russell J. Steel, Salem, UT (US); Richard A. Flak, Springville, UT (US)

Correspondence Address: MORRISS O'BRYANT COMPAGNI, P.C., 136 SOUTH MAIN STREET, SUITE 700, SALT LAKE CITY, UT, 84101, US

(21) Appl. No.: 11/311,929

(22) Filed: Dec. 19, 2005

Related U.S. Application Data
(60) Provisional application No. 60/637,223, filed on Dec. 17, 2004.

(51) Int. Cl. B23K 20/12; B23K 37/00

(52) U.S. Cl. 228/2.1

(57) ABSTRACT

A single body friction stir welding tool, wherein the single body is pressed/sintered as a single body tool in a single pressing operation, and wherein different tool design characteristics can be introduced into the single body tool.

### CROSS REFERENCE TO RELATED APPLICATIONS

This document claims priority to and incorporates by reference all of the subject matter included in the provisional patent application having docket number 3208.SMII.PR, with Ser. No. 60/637,223 and filed on Dec. 17, 2004, and the subject matter in Continuation patent applications having docket number 1219.BYU.CN with Ser. No. 10/705,668 and filed on Nov. 10, 2003, and docket number 1219.BYU.CN2 with Ser. No. 10/705,717 and filed on Nov. 10, 2003.

### BACKGROUND OF THE INVENTION

1. Field of the Invention

This invention relates generally to friction stir welding, friction stir processing, and friction stir mixing. More specifically, the invention relates to a single body tool concept for friction stir welding, processing and mixing of high melting temperature materials.

2. Description of Related Art and the Problems Being Solved

Friction stir welding (hereinafter “FSW”) is a technology that has been developed for welding metals and metal alloys. The FSW process often involves engaging the material of two adjoining workpieces on either side of a joint by a rotating stir pin or spindle. Force is exerted to urge the spindle and the workpieces together and frictional heating caused by the interaction between the spindle and the workpieces results in plasticization of the material on either side of the joint. The spindle is traversed along the joint, plasticizing material as it advances, and the plasticized material left in the wake of the advancing spindle cools to form a weld.

FIG. 1 is a perspective view of a tool being used for friction stir welding that is characterized by a generally cylindrical tool 10 having a shoulder 12 and a pin 14 extending outward from the shoulder. The pin 14 is rotated against a workpiece 16 until sufficient heat is generated, at which point the pin of the tool is plunged into the plasticized workpiece material. The workpiece 16 is often two sheets or plates of material that are butted together at a joint line 18. The pin 14 is plunged into the workpiece 16 at the joint line 18. Although this tool has been disclosed in the prior art, it will be explained that the tool can be used for a new purpose. It is also noted that the terms “workpiece” and “base material” will be used interchangeably throughout this document.

The frictional heat caused by rotational motion of the pin 14 against the workpiece material 16 causes the workpiece material to soften without reaching a melting point. The tool 10 is moved transversely along the joint line 18, thereby creating a weld as the plasticized material flows around the pin from a leading edge to a trailing edge. The result is a solid phase bond 20 at the joint line 18 that may be generally indistinguishable from the workpiece material 16 itself, in comparison to other welds.

It is observed that when the shoulder 12 contacts the surface of the workpieces, its rotation creates additional frictional heat that plasticizes a larger cylindrical column of material around the inserted pin 14. The shoulder 12 provides a forging force that contains the upward metal flow caused by the tool pin 14.

During FSW, the area to be welded and the tool are moved relative to each other such that the tool traverses a desired length of the weld joint. The rotating FSW tool provides a continual hot working action, plasticizing metal within a narrow zone as it moves transversely along the base metal, while transporting metal from the leading face of the pin to its trailing edge. As the weld zone cools, there is typically no solidification as no liquid is created as the tool passes. It is often the case, but not always, that the resulting weld is a defect-free, re-crystallized, fine grain microstructure formed in the area of the weld.

Travel speeds are typically 10 to 500 mm/min with rotation rates of 200 to 2000 rpm. Temperatures reached are usually close to, but below, solidus temperatures. Friction stir welding parameters are a function of a material's thermal properties, high temperature flow stress and penetration depth.

Previous patents by some of the inventors such as U.S. Pat. Nos. 6,648,206 and 6,779,704 have taught the benefits of being able to perform friction stir welding with materials that were previously considered to be functionally unweldable. Some of these materials are non-fusion weldable, or just difficult to weld at all. These materials include, for example, metal matrix composites, ferrous alloys such as steel and stainless steel, and non-ferrous materials. Another class of materials that were also able to take advantage of friction stir welding is the superalloys. Superalloys can be materials having a higher melting temperature bronze or aluminum, and may have other elements mixed in as well. Some examples of superalloys are nickel, iron-nickel, and cobalt-based alloys generally used at temperatures above 1000 degrees F. Additional elements commonly found in superalloys include, but are not limited to, chromium, molybdenum, tungsten, aluminum, titanium, niobium, tantalum, and rhenium.

It is noted that titanium is also a desirable material to friction stir weld. Titanium is a non-ferrous material, but has a higher melting point than other nonferrous materials.

The previous patents teach that a tool is needed that is formed using a material that has a higher melting temperature than the material being friction stir welded. In some embodiments, a superabrasive was used in the tool.

The embodiments of the present invention are generally concerned with these functionally unweldable materials, as well as the superalloys, and are hereinafter referred to as “high melting temperature” materials throughout this document.

While the examples above have addressed friction stir welding, friction stir processing and friction stir mixing are also aspects of the invention that must be considered. It is noted that friction stir processing and welding may be exclusive events of each other, or they may take place simultaneously. It is also noted that the phrase “friction stir processing” may also be referred to interchangeably with solid state processing. Solid state processing is defined herein as a temporary transformation into a plasticized state that typically does not include a liquid phase. However, it is noted that some embodiments allow one or more elements to pass through a liquid phase, and still obtain the benefits of the present invention.

In friction stir processing, a tool pin is rotated and plunged into the material to be processed. The tool is moved transversely across a processing area of the material. It is the act of causing the material to undergo plasticization in a solid state process that can result in the material being modified to have properties that are different from the original material.

Friction stir mixing can also be an event that is exclusive of welding, or it can take place simultaneously. In friction stir mixing, at least one other material is being added to the material being processed or welded.

MegaStir Technologies (a business alliance between Advanced Metal Products, Inc. and SII MegaDiamond, Inc.) has developed friction stir welding (FSW) tools that can be used to join high melting temperature materials such as steel and stainless steel together during the solid state joining processes termed FSW. This technology generally involves using a polycrystalline cubic boron nitride tip 30 (including pin and shoulder areas), insulation behind the tip (not shown), a locking collar 32, a set screw 34 and a shank 36 as shown in FIG. 2.

When this tool is used with the proper friction stir welding machine and proper steady state cooling, it is effective at friction stir welding of various materials. This tool design is also effective for using a variety of tool tip materials besides PCBN. Some of these materials include refractories such as tungsten, rhenium, iridium, titanium, etc.

Since these tip materials are often expensive to produce this design is an economical way of producing and providing tools to the market place. The design shown in FIG. 2 is in part driven by the limited sizes that can be produced by sintering, hipping, and other high pressure equipment capabilities.

It is noted that previous disclosures by some of these inventors have taught that the cost of manufacturing an entire tool as a monolithic unit would be prohibitively expensive. The inventors taught that given the advantages of other embodiments, it would be unlikely that a monolithic unit would be widely used. However, further experimentation and investigation by the inventors has resulted in novel inventive aspects being discovered.

Accordingly, it would be an advantage over the state of the art to provide a single body tool for friction stir welding, processing and/or mixing of high melting temperature materials such as steel and stainless steel.

### BRIEF SUMMARY OF THE INVENTION

It is an object of the present invention to provide a single body tool for performing friction stir welding of high melting temperature materials.

It is another object to provide a composite single body friction stir welding tool.

In a preferred embodiment, the present invention is a single body friction stir welding tool, wherein the single body is pressed/sintered as a single body tool in a single pressing operation, wherein different tool design characteristics can be introduced into the single body tool.

These and other objects, features, advantages and alternative aspects of the present invention will become apparent to those skilled in the art from a consideration of the following detailed description taken in combination with the accompanying drawings.

### BRIEF DESCRIPTION OF THE SEVERAL VIEWS OF THE DRAWINGS

FIG. 1 is a prior art perspective view of an existing friction stir welding tool capable of performing FSW on high melting temperature materials

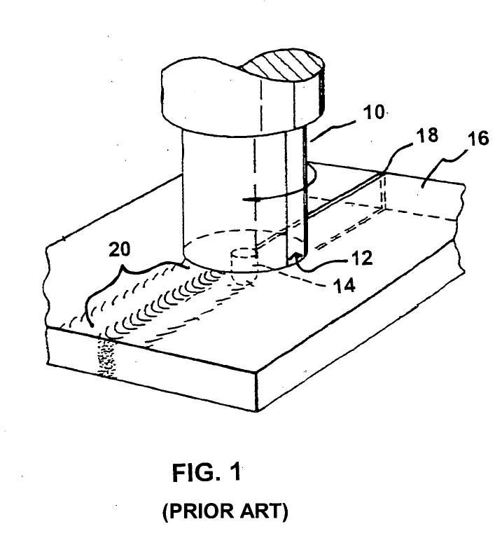

FIG. 2 is another prior art perspective view of an existing friction stir welding tool capable of performing FSW on high melting temperature materials.

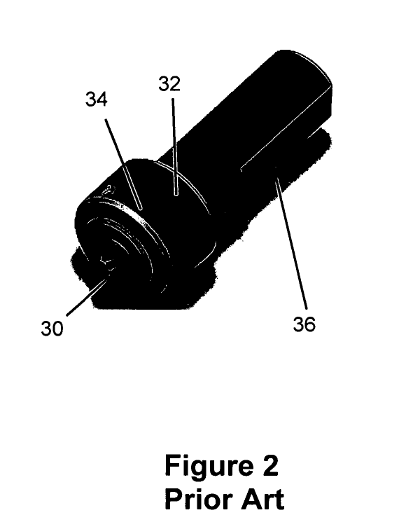

FIG. 3 is a perspective view of a composite single body FSW tool as described in the present invention.

### DETAILED DESCRIPTION OF THE INVENTION

Reference will now be made to the figures and to the details of the invention in which the various elements of the present invention will be described and discussed so as to enable one skilled in the art to make and use the invention. It is to be understood that the following description is only exemplary of the principles of the present invention, and should not be viewed as narrowing the claims which follow.

Recent advances in high pressure and ultra high pressure material fabrication equipment have made it possible to economically fabricate larger single body tools that can successfully friction stir weld, process and/or mix high temperature materials. This new ability to manufacture a single body tool can be used to press/sinter the tool in a single pressing operation, and allows for different tool design characteristics that are design improvements over existing designs.

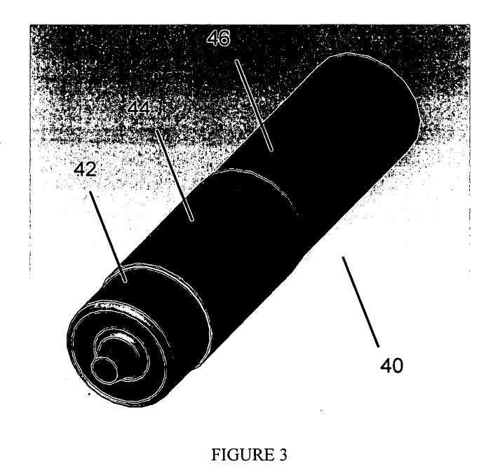

In one embodiment of the present invention, a single body tool can be pressed in a single pressing operation. Different materials can be put into a press together. Thus, the pressing operation can create a single body tool having layers of different materials. A single body tool 40 having more than one material used in its construction is illustrated in FIG. 3. In FIG. 3, a first material 42 is shown being used for the pin and shoulder areas, a second material 44 adjacent to the pin and shoulder area, and a third material 46 adjacent to the second material.

Likewise, in a different embodiment of the present invention, a single material can be put into a press to create a single body tool that is monolithic.

It should be stressed that the definition of a single body tool is broader than a tool having a shank, a shoulder, and a pin. For the simple reason that tools have been developed that include a shank and shoulder only, as well as stand-alone inserts, it should be considered an aspect of the present invention that any of the tool elements can be created as a single body unit.

In another aspect of the present invention, it is noted that tool holders can function in the role of a portion of the body of the single body tool. For example, a short body having a shoulder can be coupled to a tool holder which functions the shank of the shorter single body tool. Likewise, the tool holder could hold a pin or insert, which the tool holder again functioning as the shank of the single body tool. These and other configurations that allow the tool holder to serve a more versatile role should be considered to be within the scope of the present invention.

After the desired tool shape has been pressed, finishing procedures can be used to further refine the single body tool. For example, it is often desirable to refine angles or depth of a shoulder, and the profile of a pin. For example, the single body tool can be finished to have a flat (not shown) to allow torque to be transmitted to the tool from the spindle. Any other mechanical locking means can be used to transmit spindle torque to the tool (i.e. multiple flats, threads, collets, chucks, etc.). Thus, the single body tool can be finished using grinding, machining, EDM or other industry standard material removal techniques.

In another embodiment of the present invention, the single body tool can be made using dual phase type materials (i.e. PCBN, CBN first phase and catalytic second phase), with all of the advantages that can be obtained from such dull phase materials.

In another embodiment, the single body tool can be made using multiphase and multimodal materials and sizes. For example, a superabrasive material being made up of 2 phases (such as PCBN and a 2^{nd} phase catalyst) can be made part of the single body tool. The composition of the superabrasive can vary. For example, it could be comprised only of PCBN. In addition, the particle size can vary substantially. For example, in PCBN, the powder size ranges from ½ up to 500 μm and can contain a combination of different sizes.

The single body tool of the present invention may be fabricated at pressures above 10,000 psi and temperatures exceeding 500 degrees Centigrade. Heat can be applied to the single body tool during the pressing operation using conductive, inductive, radiative or convective heating.

The single body tool of the present invention may be fabricated using a refractory material container to thereby contain the material being used for the single body tool during pressing. Materials for the single body tool include materials found in the metals section of the periodic table of the elements.

The single body tool may be fabricated having cross sections and radial sections that have gradients in thermal conductivity, transverse rupture strength, Young's modulus, electrical resistivity, particle size distribution.

When more than one material is being pressed together to form the single body tool, the tool can also be fabricated having gradients and interfaces between the different materials.

The present invention includes any tool configuration that allows for a shoulder material to be different from a pin, when the pin is present. Likewise, the shoulder material can be different from a shank material, if the shank is present.

Any tool containing refractory materials, cubic boron nitride, diamond, superabrasive, ceramic or elements found in the non-metallic, brittle metal, ductile metal and lanthanide section of the periodic table of the elements should all be considered to be within the scope of the present invention.

It is noted that as the PCBN blank gets larger, there is likely to be a greater heat capacitance of the single body tool, depending on the configuration of the single body tool. Accordingly, brazing on the single body tool may be an option if temperature management is managed to keep the temperature below the brazing “wetting” temperature while maintaining the required mechanical properties of the single body tool.

The metallurgy of the single body tool can also be modified to provide more of a thermal barrier in the microstructure at the brazed end of the tool.

It is to be understood that the above-described arrangements are only illustrative of the application of the principles of the present invention. Numerous modifications and alternative arrangements may be devised by those skilled in the art without departing from the spirit and scope of the present invention. The appended claims are intended to cover such modifications and arrangements.

What is claimed is:

1. A single body tool for performing friction stir welding, processing or mixing of high melting temperature materials, said single body tool comprising:
a single body tool that is pressed as a single unit in a single pressing process; and
a superabrasive material disposed on at least a portion of the single body tool, wherein the superabrasive material is manufactured under an ultra high temperature and an ultra high pressure process, and wherein the single body tool is capable of functionally friction stir welding, processing or mixing of high melting temperature materials.

2. The single body tool as defined in claim 1 wherein the single body tool further comprises a shank, a shoulder and a pin.

3. The single body tool as defined in claim 1 wherein the single body tool further comprises a shoulder and a pin.

4. The single body tool as defined in claim 1 wherein the single body tool further comprises a shank and a shoulder.

5. The single body tool as defined in claim 1 wherein the single body tool further comprises a plurality of different materials being combined in the single pressing process.

6. The single body tool as defined in claim 1 wherein the single body tool further comprises a single material being pressed to form all portions of the single body tool.

7. The single body tool as defined in claim 1 wherein the single body tool further comprises dual phase type materials being pressed together in the single pressing process.

8. The single body tool as defined in claim 1 wherein the single body tool is finished using a method selected from the group of finishing techniques comprised of grinding, brazing, machining, EDM and other industry standard material removal techniques.

9. The single body tool as defined in claim 1 wherein the single body tool is pressed in a container that is comprised of refractory materials.

10. The single body tool as defined in claim 1 wherein the single body tool is pressed having cross sections that have gradients that are selected from the group of cross section gradients comprised of thermal conductivity, transverse rupture strength, Young's modulus, electrical resistivity, and particle size distribution.

11. The single body tool as defined in claim 1 wherein the single body tool is pressed having radial sections that have gradients that are selected from the group of radial section gradients comprised of thermal conductivity, transverse rupture strength, Young's modulus, electrical resistivity, and particle size distribution.

12. The single body tool as defined in claim 5 wherein the plurality of different materials include gradients or interfaces between the plurality of different materials.

13. A method for manufacturing a single body tool for performing friction stir welding, processing and mixing of high melting temperature materials, said method comprising the steps of:
(1) providing a form for a single body tool;
(2) disposing a superabrasive material into the form wherein the superabrasive material will function as a coating on the single body tool, and wherein the superabrasive material is manufactured under an ultra high temperature and an ultra high pressure process;
(3) disposing at least one material into the form, wherein the at least one material will become the body of the single body tool; and
(4) pressing the materials in the form in a single pressing process to thereby create the single body tool that is capable of functionally friction stir welding, processing or mixing high melting temperature materials.

14. The method as defined in claim 13 wherein the method is further comprised of the step of disposing a plurality of materials into the form that are used to create the body of the single body tool.

15. The method as defined in claim 13 wherein the method is further comprised of the step of disposing dual phase type materials into the form that are used to create the body of the single body tool.

16. The method as defined in claim 13 wherein the method is further comprised of the step of single body finished the single body tool using a method selected from the group of finishing techniques comprised of grinding, brazing, machining, EDM and other industry standard material removal techniques.

17. The method as defined in claim 13 wherein the method is further comprised of the step of creating the form from refractory materials.

18. The method as defined in claim 13 wherein the method is further comprised of the step of pressing the single body tool so that there is at least one cross section that has gradients that are selected from the group of cross section gradients comprised of thermal conductivity, transverse rupture strength, Young's modulus, electrical resistivity, and particle size distribution.

19. The method as defined in claim 13 wherein the method further comprises the step of pressing the single body tool so that there is at least one radial section that has gradients that are selected from the group of radial section gradients comprised of thermal conductivity, transverse rupture strength, Young's modulus, electrical resistivity, and particle size distribution.

20. The method as defined in claim 14 wherein the method further comprises the step of creating gradients or interfaces between the plurality of different materials used for the single body tool.
